(19) United States
(12) Patent Application Publication
(10) Pub. No.: US 2011/0171356 A1
(43) Pub. Date: Jul. 14, 2011

(54) FROZEN BLEND OF SAUCE AND VEGETABLES

(76) Inventors: Peter H. Mattson, Hillsborough, CA (US); Scott Loh, San Carlos, CA (US)

(21) Appl. No.: 12/939,094

(22) Filed: Nov. 3, 2010

Related U.S. Application Data
(60) Provisional application No. 61/280,428, filed on Nov. 3, 2009.

(51) Int. Cl. A23C 19/00; A23L 1/025

(52) U.S. Cl. 426/241; 426/582

(57) ABSTRACT

A frozen Queso Fundido preparation or similar product is formed in individual frozen chunks so as to be conveniently microwavable. A cheese sauce is first prepared, including heating the cheese with salts, starch and any other desired ingredients, then cooling the sauce in a sheet and freezing it. The frozen sauce is cut into cubes or other chunks and kept frozen. Separately, vegetables, meat or other ingredients are frozen in chunks and the frozen vegetable chunks are placed with the cheese sauce chunks in packaging and sealed. The consumer takes the frozen package, empties it into a bowl and microwaves the chunks together. The individual chunks will thaw and melt efficiently.

### BACKGROUND AND SUMMARY OF THE INVENTION

The invention concerns a dish that includes a sauce with vegetables or meat. The dish can be of the type commonly known as Queso Fundido. The invention encompasses a frozen cheese sauce/particulate product and methods for its preparation and use.

Traditional Queso Fundido is a Mexican cheese sauce that is melted in the oven and served with tortillas or tortilla chips. Its primary ingredient is Oaxacan style melting cheese called queso asadero. Roasted vegetables and grilled meats are sometimes added to the sauce. One of the issues with traditional Queso Fundido is fat separation/pooling, and once cooled the sauce congeals into a firm cheese block which is difficult and time-consuming to thaw. Another issue is that large particulates (meat, vegetable, etc.) have not been practical and could not be maintained in prior cheese sauces. If the chunks were blended into the sauce during processing, this would tend to macerate the chunks into small pieces. Also, vegetables do not appear fresh when combined in this way.

According to this invention, a cheese sauce product, including vegetables and/or meat, is prepared and maintained frozen for consumer purchase, the preparation being such as to eliminate the objectionable fat separation, to maintain the soft texture of the sauce as it cools, and such that the preparation is readily and efficiently microwavable by the consumer. Large chunks of vegetables and/or meat (particulates) can be included.

By the process of the invention, the cheese sauce with cheese, emulsifying salts, food starch and other ingredients is prepared by heating and mixing, then formed into a sheet and frozen. The frozen sauce is cut into chunks, which may be in the range of about ¼ inch to 1 inch in size, and maintained frozen. Vegetable and/or meat or fish chunks (which can be a mix of vegetables or a mix of vegetables with meat or fish) are individually quick frozen (IQF) separately, and the vegetable or meat chunks are then combined, still frozen, in a package with the frozen cheese sauce chunks. The package is sold frozen to the consumer, who microwaves the frozen chunks of sauce or meat or vegetables together.

It is among the objects of the invention to provide a frozen cheese sauce/particulate product that is efficiently produced, efficiently heated for use by the consumer, and can include large particulates. These and other objects, advantages and features of the invention will be apparent from the following description of a preferred embodiment, considered along with the accompanying drawings.

### DESCRIPTION OF PREFERRED EMBODIMENTS

In one preferred form of the cheese sauce preparation and process of the invention, the ingredients and process are as listed below.

Ingredients:

1. Cheese of a meltable type (queso asadero, mozzarella,

Monterey jack, white or orange cheddar, etc.), preferably grated: Approx. 65% (at least about 55% by weight)

2. Heavy cream (about 35% fat, or a range of about 25% to 45% fat): About 32% (about 25% to 40%)

3. Emulsifying salts: About 0.8% (0.5% to 1.5%)

4. Food starch: About 0.65% (0.2% to 1.0%)

5. Salt: About 0.5% to 1.5% (if included)

Basic Process of Ready to Microwave Queso Fundido:

1. Grate Queso Asadero to approx. 2×2 mm

2. Combine emulsifying salts, starch and cheese

3. Heat all ingredients in steam jacketed kettle and mix with scrape surface paddles.

4. Bring cheese mixture to 180° F. (range of about 180° to 200° F., or sufficient to fully melt and preferably pasteurize cheese mixture) and continue mixing for 5 min. (or until fully mixed)

5. Transfer cheese to cooling tray and freeze as a sheet.

6. Cut into 1×1″ approx. cubes, or a size range of about ¼″ to 1½″, not necessarily cubic.

7. Keep frozen Finished pH: Approx. 5.4 (range of about 5 to 6)

Consumer Packaging (Example):

1. 6 oz. of frozen cheese cubes

2. 4 oz. grilled vegetables (or meat of fish) individually quick frozen, chunk size about ⅛″ to 1″

Consumer Direction:

1. Heat pouch into a microwave safe bowl

2. Heat on high for about 2 min. or until cheese cubes are fully melted and hot

3. Stir and serve with chips or fresh tortillas

The above quantities and sizes represent a preferred embodiment of the method and product of the invention and can vary.

The consumer-heated product is a cheese sauce full of large particulates (vegetables, meat or fish), the particulates preferably being in the range of about ⅛ inch to 1 inch in size. In the process, the vegetable/meat particulates preferably are individually quick frozen, so that each is a separate frozen chunk rather than being agglomerated together.

In a preferred form of the preparation, the particulates (vegetables, or meat, etc.) constitute about 30% to 50% by weight in the package, with the cheese sauce constituting about 70% to 50% by weight, and in one preferred product the ratio is about 40:60. All percentages and proportions herein are by weight.

In the process, once the cheese has been formed into a sheet and frozen, it can be cut into any desired shape, with the maximum dimension of the sauce chunks being in the stated preferred range of about ¼ inch to about 1½ inch.

The method and product of the invention prevent agglomeration of components into large frozen bodies, or into a large block in the case of the cheese sauce, as well as avoiding the fat/oil separation and pooling noted above. The result is a more readily and efficiently microwavable end product which remains aesthetic throughout consumer preparation.

Also, as explained above, prior processes have blended sauce and particulates. By avoiding blending, the process herein provides for large chunks of vegetables, meat, etc., each individually quick frozen, to remain in essentially fresh condition and in large size, and to be combined by the consumer with the frozen sauce chunks for heating together. Vegetable chunks are thus not heated until consumption.

Further, the product and method of the invention permit the use of a single cheese sauce with a variety of different types of particulates, for a variety of different end products.

In the claims, references to “meat” in the product or process of the invention is to be understood as meaning meat, fish or chicken, and “vegetable or meat” is intended to include a combination of both. “Cutting” the cheese includes grating.

The above described preferred embodiments are intended to illustrate the principles of the invention, but not to limit its scope. Other embodiments and variations to these preferred embodiments will be apparent to those skilled in the art and may be made without departing from the spirit and scope of the invention.

We claim:

1. A method for producing a frozen cheese sauce dish including particulate vegetable or meat chunks, comprising:
cutting a meltable cheese into small pieces,
combining the cheese with emulsifying salts, food starch and heavy cream,
heating the combined cheese mixture in a vessel and mixing while heating, and bringing the mixture to a temperature high enough to fully melt the cheese, and continuing mixing the resulting cheese sauce until thoroughly mixed,
transferring the cheese sauce to a cooling tray and raising the cheese sauce as a sheet,
cutting the frozen cheese sauce into pieces, and maintaining the cheese sauce pieces frozen,
individually quick freezing vegetable or meat chunks in chunk sizes of about ⅛ inch to one inch, and placing the frozen cheese sauce pieces with the frozen vegetable or meat chunks in a package and maintaining the package frozen.

2. The method of claim 1, wherein the cheese is grated to form the small pieces.

3. The method of claim 1, wherein the cheese is at least about 55% of the combined mixture by weight.

4. The method of claim 1, wherein the eating step is carried out in a steam jacketed kettle and mixing is done using scrape surface paddles.

5. The method of claim 1, wherein the heating step includes bringing the mixture to about 180° to 200° F.

6. The method of claim 5, wherein the mixing at 180° to 200° F. continues for about five minutes.

7. The method of claim 1, wherein the cheese is queso asadero, mozzarella or Monterey Jack cheese.

8. The method of claim 1, wherein the heavy cream in the mixture is about 25% to 40% by weight in the mixture.

9. The method of claim 1, wherein the combining step further includes adding salt.

10. The method of claim 1, wherein the meltable cheese is cut into pieces at least as small as about 2 mm by 2 mm.

11. The method of claim 1, wherein the frozen cheese sauce is cut into approximately cubic pieces one inch on a side.

12. The method of claim 1, wherein the cheese sauce has a pH of about 5 to 6.

13. The method of claim 1, wherein the cheese and heavy cream are present in a ratio of about 2:1 by weight.

14. The method of claim 1, wherein the frozen cheese sauce pieces placed in the package are about 60% and the frozen vegetable or meat chunks are about 40%, by weight.

15. The method of claim 1, wherein the meltable cheese in the combining step is at least about 50% by weight of the combined mixture.

16. The method of claim 1, wherein the temperature in the heating step is high enough to pasteurize the combined mixture.

17. The method of claim 1, wherein the frozen cheese sauce is cut into pieces of size about ¼ inch to 1½ inch.

18. A method for producing a ready to eat cheese sauce dish including particulate vegetable or meat chunks, comprising:
placing the contents of the package produced according to claim 1, including frozen cheese sauce pieces and frozen vegetable or meat chunks, into a vessel, and
heating the vessel in a microwave oven at high setting for a time sufficient to fully melt the cheese sauce, then stirring the melted cheese sauce and chunks together.

19. The method of claim 17, wherein the time of microwave heating is at least about two minutes.

20. The method of claim 17, wherein the frozen cheese sauce pieces placed in the package are about 60% and the frozen vegetable or meat chunks are about 40%, by weight.
